(19) United States
(12) Patent Application Publication
(10) Pub. No.: US 2009/0098855 A1
(43) Pub. Date: Apr. 16, 2009

(54) METHOD AND SYSTEM FOR PROVISIONING COMMUNICATION SERVICE TO A MOBILE COMMUNICATION DEVICE TO RESTRICT USE WHEN OPERATING A VEHICLE

(75) Inventors: Jose M. Fernandez, Sunrise, FL (US); Darcy C. Ahl, Darien, CT (US); Frank J. Farrell, JR., Wilton, CT (US); Joe Mangione, Cedar Grove, NJ (US); Stephen R. Vowell, Houston, TX (US)

Correspondence Address: EDWARDS ANGELL PALMER & DODGE LLP, P.O. BOX 55874, BOSTON, MA, 02205, US

(73) Assignee: CellBlock Telecommunications Company, Inc., New Canaan, CT (US)

(21) Appl. No.: 11/956,067

(22) Filed: Dec. 13, 2007

Related U.S. Application Data
(60) Provisional application No. 60/979,263, filed on Oct. 11, 2007.
(60) Provisional application No. 60/987,520, filed on Nov. 13, 2007.

(51) Int. Cl. H04Q 7/20; H04M 1/66; G08B 5/22

(52) U.S. Cl. 455/410; 455/404.1; 340/7.24

(57) ABSTRACT

A mobile communication device has communication service restricted when it becomes apparent that the device is in transit. The communication system receives an access control message indicating the device is in transit. The system accesses a mobility access profile stored in a database. The mobility access profile indicates provisioning changes to be made in providing communication service to the mobile communication device while the device is in transit.

### CROSS-REFERENCE TO RELATED APPLICATIONS

This Application is a Non-Provisional of Provisional application 60/979,263 entitled METHOD AND SYSTEM FOR PROVISIONING COMMUNICATION SERVICE TO A MOBILE COMMUNICATION DEVICE TO RESTRICT USE WHEN OPERATING A VEHICLE filed on Oct. 11, 2007; and application 60/987,520 entitled METHOD AND SYSTEM FOR PROVISIONING COMMUNICATION SERVICE TO A MOBILE COMMUNICATION DEVICE TO RESTRICT USE WHEN OPERATING A VEHICLE filed on Nov. 13, 2007 under (35 USC 119(e)).

### BACKGROUND OF THE INVENTION

1. Field of the Invention

The invention relates generally to mobile communication, and more particularly to restricting communication service provided to a mobile communication device when it is apparent that the mobile communication device is being used in a vehicle.

2. Background of the Invention

The problem of mobile communication devices being used by people while operating vehicles is well known. Drivers tend to become distracted and are at a higher risk of being involved in a driving-related incident, such as a collision or unintended departure from the roadway. Some reports indicate the problem of “driving while talking” is equal to the problem of driving while under the influence of alcohol or other intoxicants. The risk seems to be particularly elevated among young, inexperienced drivers. Other reports indicate the problem is reflected in rising automobile insurance rates.

To address the problem, various governmental entities have examined the problem, and have taken action such as banning the use of mobile communication devices while operating a vehicle. However, users may still access communication resources, despite such a ban. A different solution that has been published is a signal “jammer” that interferes with the radio operation of the mobile communication device. Such a solution would likely not be viable, though, as the interference is indiscriminate and would interfere with any mobile communication devices operating on the same or similar frequencies in the vicinity of the jammer. Such interference would likely be against regulations of transmitting devices in many jurisdictions. Another solution that has been suggested is to provide a wireless communication manager unit through which call audio is routed, and which is mounted in the vehicle. The wireless communication manager unit interfaces with the vehicle's control system to determine the speed of the vehicle. Audio, power, and radio frequency signals are routed through the wireless communication manager unit and a “free hand kit” to the mobile communication device. When the vehicle is moving at or above a predetermined speed, as indicated by the vehicle's control system, the wireless communication manager unit inhibits operation of the mobile communication device by suppressing audio signals. However, this approach requires the user to connect the mobile communication device to the “free hand kit” and wireless communication manager unit. The user of the mobile communication device may still simply hold the mobile communication device and use it without connecting it to the other units.

Thus, there is a need for a means by which communication service to a mobile communication device can be affected which does not interfere with other users' devices, and which requires a higher degree of compliance by the user.

### BRIEF SUMMARY OF THE INVENTION

A method for provisioning communication service provided to a mobile communication device by a communication system. An access control message is received at an access control processor of the communication system. The access control message indicates whether the mobile communication device is traveling or if the vehicle associated with the mobile communication device is being operated. A mobility access profile is associated with the mobile communication device in response to the access control message. The mobility access profile includes provisioning parameters associated with the mobile communication device. A mobile switching center of the communication system applies the parameters of the mobility access profile to control access to the mobile communication device when the communication device is moving.

### BRIEF DESCRIPTION OF THE DRAWINGS

FIG. 1 is a schematic drawing of a communications system and a mobile communication device associated with a vehicle in accordance with an embodiment of the invention;

FIG. 2 is a block diagram of a vehicle module for use in controlling provisioning of a mobile communication device in accordance with an embodiment of the invention;

FIG. 3 is a block diagram of a vehicle system for controlling provisioning of a mobile communication device in accordance with another embodiment of the invention;

FIG. 4 is a block diagram of a mobile communication device for use with the invention, in accordance with yet another embodiment of the invention;

FIG. 5 is a flow chart of a method for controlling provisioning a mobile communication device in accordance with the invention;

FIG. 6 is a flow chart of a method for controlling provisioning a mobile communication device in accordance with still another embodiment of the invention;

FIG. 7 is a flow chart of a method for controlling provisioning a mobile communication device in accordance with a further embodiment of the invention; and

FIG. 8 is a flow chart of a method for generating or updating a mobility access profile in accordance with the invention.

### DETAILED DESCRIPTION OF THE INVENTION

Various modifications to the preferred embodiment and the generic principles and features described herein will be readily apparent to those skilled in the art. Thus, the present invention, as described below in each of its embodiments, is not intended to be limited to the embodiment shown but is to be accorded the widest scope consistent with the principles and features described herein.

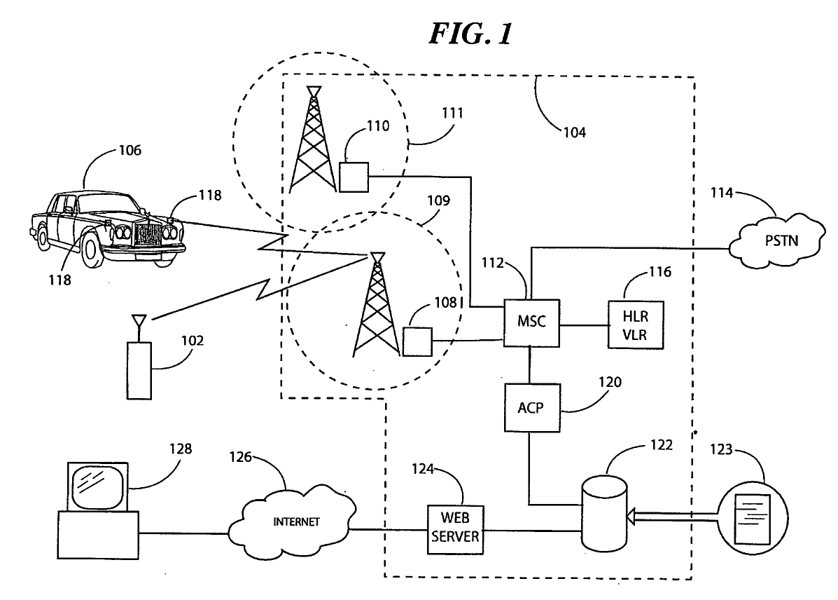

A system for controlling a mobile communication, generally indicated as 100, as shown in FIG. 1, includes a mobile communication device 102, such as a cellular telephone, personal digital assistant, two-way pager or the like. A communication system 104 provides access to and from communication device 102. The user of the mobile communication device 102 may use a vehicle 106 to drive to various destinations. Communication system 104 includes a base station 108, which provides a radio air interface to subscribing mobile communication devices 102 in the vicinity of base station 108. The region in which a communication device 102 accesses a base station, such as base station 108, is referred to as a serving cell 109. Mobile communication device 102 may travel to other cells, and communication system 104 will hand over communication service to each new serving cell 109 as the device changes cell affiliation, as is well known. A nearby base station 110 and its associated cell 111 are referred to as a neighbor cell. Quite often, even though mobile communication device 102 is affiliated with a serving cell 109, it can receive and measure signals from the neighbor cell 111 to determine, for example, when to make a handover or for reporting to the control systems (described below) communication system 104, which may determine when a handover is needed.

The air interface provided by the base stations 108, 110 allows access to a mobile switching center (MSC) 112. MSC 112 controls calling and other communication activity, and is connected to a public switched telephone network (PSTN) 114. MSC sets up communication circuits for various modes of communication, in accordance with request and authorization as known in the art. MSC 112 controls communication access for subscribing and authorized roaming mobile communication devices 102 in accordance with a home location register and visit location register (HLR VLR) 116. HLR/VLR 116 maintains subscriber information and other parameters relating to mobility management, access control, and so on, which governs the manner in which mobile communication device 102 operates within communication system 104.

In accordance with the invention, communication system 104 is informed of the apparent travel of mobile communication device 102. Communication system 104 may be informed from any one of at least two sources. First, the mobile communication device 102 itself may report to the communication system 104 that mobile communication device appears to be traveling. Second, a vehicle module 118 disposed in vehicle 106 may report to communication system 104 when vehicle 106 is being operated or is traveling. As used herein, the terms travel and transit concerning mobile communication device 102 refer to motion at a rate sufficient to indicate the mobile communication device is in a moving vehicle, not simply moving at, for example, a walking pace.

When conditions indicate that mobile communication device 102 is in transit, communication system 104 receives an access control message (ACM). An ACM is created by vehicle module 118, or other mechanisms as discussed in other embodiments below responsible for determining movement of mobile communication device 102. The ACM is an information signal which includes information regarding position, velocity, relative position to a cell 109, 111 or the like as well as identifying information such as the communication address for mobile communication device 102 (i.e., telephone number) or the vehicle module or the like. Utilizing this information, the ACM enables MSC 112 to determine whether or not the communication circuit needs to be reconfigured to accommodate mobile communications device 102 in motion.

MSC 112 recognizes the ACM and routes it to an access control processor (ACP) 120 as a function of the information contained in the ACM. ACP 120 then accesses an access database 122 to retrieve a mobility access profile (MAP) 123 stored therein. MAP 123 is a file or record including provisioning parameters and information for setting the provisioning settings for each subscribing mobile communication device 102 in communication system 104. MAP123 may be stored or recorded in any suitable format or known data structure. The information in MAP 123 is provided to MSC 112 by ACP 120, which then applies the provisioning setting associated with mobile communication device 102. More particularly, access to communication resources of communication system 104 by mobile communication device 102 is restricted. Communication system 104 may, for example, deny call setup requests, peer-to-peer messaging, Internet access, route incoming calls to a voice mail account associated with the mobile communication device, and so on as a function of switching instructions stored as MAP 123 and processed by MSC 112 and ACP 120. Communication system 104 may further allow exceptions to the restrictions. For example, calling specific phone numbers, such as a home number or a parent's cellular phone number may be allowed while all others are blocked. Additionally, calls to emergency services may be excepted from the restrictions as such parameters are stored as MAP 123. Alternatively, generic instructions such as allowing all emergency calls (911 for example), may be “hardwired” into MSC 112 or ACP 120.

Once the information in MAP 123 is provided to MSC 112, MSC 112 then updates the present provisioning parameters associated with the mobile communication device. The present provisioning parameters may be stored, for example, in the VLR 116, and may be accessed by MSC 112 when mobile communication device 102 requests communication resources, or when incoming communications are received which are bound for mobile communication device 102.

Communication system 104 may allow authorized subscribers to generate and update MAP 123. Communication device 104 includes a web server 124, which provides an interface over Internet connection 126 so that remote parties 128 may enter and edit parameters and other information to be included in MAP 123. Web server 124 may present an input page to the user, who is an owner of, or an authorized person, associated with mobile communication device 102, for receiving information from the user. Once the user is authenticated and has entered the desired information, web server 124 then accesses the access database 122 and updates or generates the appropriate MAP 123.

In summary, profiles including parameters for operation of a target mobile communication device 102 are stored in a database 122 as MAP 123. MAP 123 includes parameters under which the target mobile communication device 102 is to operate when in motion. A module that monitors the movement of a vehicle associated with mobile communication device 102 or in mobile communication device 102 itself continuously determines whether or not the mobile communication device 102 or associated vehicle 106 is in motion. If either is in motion, an ACM is generated and received by MSC 112, which routes the incoming ACM to an ACP 120, which determines whether or not a profile for the mobile communication device 102 associated with the generated ACM exists in MAP 123. If not, then processing goes on as is normal. If there is a profile, then MSC 112 creates a communication circuit in accordance with the parameters stored in MAP 123 which may include, by way of example, one of allowing certain phone calls to pass through, providing a busy signal, diverting the communication to an e-mail, voicemail or other communications address or the like. This methodology works whether the information is attempted to be originated at mobile communications device 102 or whether mobile communications device is the target communications device.

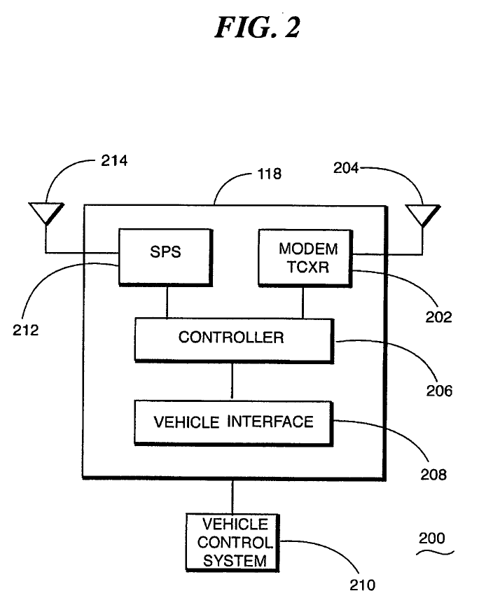

FIG. 2 shows a schematic diagram of a vehicle mounted control system generally indicated as 200. Vehicle mounted control system 200 includes a vehicle module 118 for use in controlling the provisioning of a mobile communication device 102 in accordance with an embodiment of the invention. Vehicle module 118 is mounted in the vehicle, which the user of mobile communication device 102 will operate. It contains a modem 202 including a radio frequency transceiver capable of accessing an interface with communication system 104 via an antenna 204. Vehicle module 118 transmits an access control message (ACM) to communication system 104, and specifically to the ACP 120 or its functional equivalent. It determines that vehicle 106 is in motion and/or is being operated. Modem 202 may use the same wireless interface provided to mobile communication device 102 as another subscribing device, or it may, for example, access an alternative wireless interface reserved for such activity. Modem 202 operates under control of a controller 206, which is programmed to carry out operations such as create an ACM in accordance with the teachings herein.

In one embodiment, controller 206 may be interfaced though a vehicle interface 208 to the vehicle control system 210. Vehicle control system 210 is the system in the vehicle that controls, for example, instrumentation, engine operation, and so on. Vehicle control system 210 may be configured to provide information to vehicle module 118 such as, for example, vehicle speed, vehicle access, the identity of a specific key or other access device used to operate the vehicle, and so on. The vehicle module may use such information to determine when to transmit the access control message. For example, when the vehicle speed reaches a preselected threshold, or if a key associated with a restricted user is used to access and operate the vehicle, the vehicle module may transmit the access control message.

Alternatively, vehicle module 118 may operate independently of vehicle control system 210 and determine use of the vehicle by other means, such as, for example, a satellite positioning receiver 212, which receives positioning signals from positioning satellites via an antenna 214. By using position information, controller 206 can determine when the vehicle is moving, at what speed and subsequently transmit the access control message.

Other means of triggering the transmission of the access control message may be used, such as pairing vehicle module 118 with mobile communication device 102 via a personal area network link. Vehicle module 118 may be installed such that pairing mobile communication device 102 with vehicle module 118 is required before vehicle module 118 allows the vehicle to start, for example, using the personal area network media access information of mobile communication device 102 as a sort of key.

Vehicle module 118 may, upon installation in target vehicle 106, be programmed with information to identify mobile communication device 102 to access control processor 120. For example, an international mobile subscriber identifier (IMSI) or simply the phone number assigned to mobile communication device 102 may be used. Alternatively, an identifier of vehicle module 118 may be associated with mobile communication device 102 at ACP 120 and, when it receives the access control message, ACP 120 cross references the vehicle module identifier with the identity of mobile communication device 102 to locate the appropriate mobility access profile 123 corresponding to mobile communication device 102.

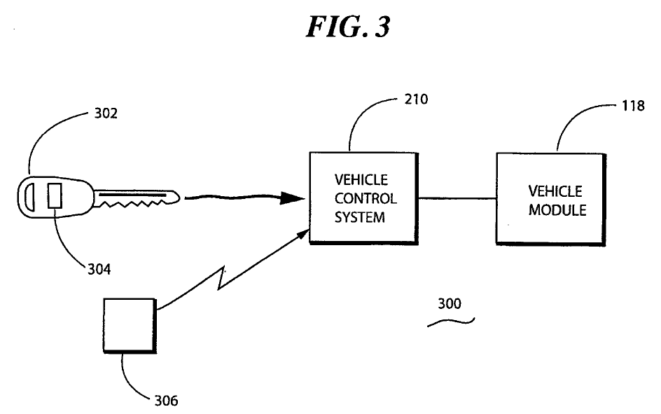

FIG. 3 shows a block diagram of a vehicle system, generally indicated as 300, for controlling provisioning of a mobile communication device 102 in accordance with another embodiment of the invention. The present example provides that the vehicle module 118 is interfaced with the vehicle control system 210. Vehicle control system 210 may detect the use of a key 302 to access and operate the vehicle 106. Automobile manufactures routinely design a standard key and a valet key, for example. Manufacturers may likewise provide a “teen” key 302 to be used by a young family member to access and operate vehicle 106. Key 302 is used by the person who also uses mobile communication device 102, which is to be restricted upon operation of vehicle 106. In addition to, or instead of key 302 having a unique mechanical configuration, key 320 may be provided with a memory element 304, which contains a unique identifier recognized by vehicle control system 210 as one that is authorized to operate the vehicle. Furthermore, it is contemplated that a wireless key 306 may be used to access the vehicle, as is known. Wireless key 306 may transmit a code to vehicle control system 210 over a short-range wireless link. This causes vehicle control system 210 to cause vehicle module 118 to output ACM as discussed above. It is further contemplated that mobile communication device 102 may be configured as a wireless key 306, using a personal area network interface such as that known in the industry by the trade name Bluetooth®, for example.

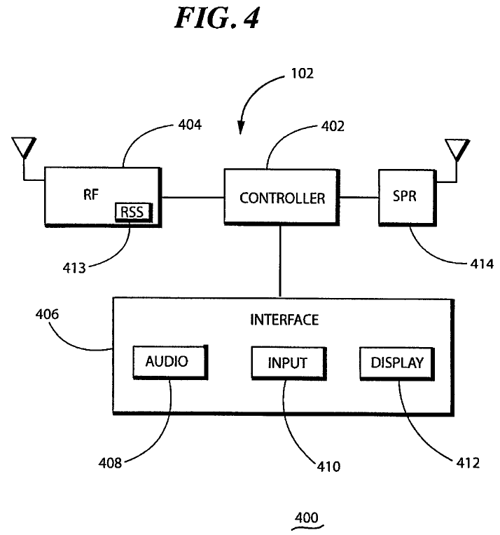

FIG. 4 shows a mobile communication device 102 for use with the invention in accordance with one embodiment of the invention. Mobile communication device 102 includes a controller 402 for controlling operation of mobile communication device 102. A radio frequency transceiver 404 provides radio access to communication system 104. An interface 406 is provided so that the user of mobile communication device 102 can interact and control operation of the device 102, and includes elements such as audio elements 408, input elements 410, and display elements 412. Audio elements 408 may include a microphone and speaker, as is conventional, and other audio transducers for generating alerts and ringing sounds. Input elements 410 may include, for example, a keypad, a liquid crystal display graphical interface or other button/entry elements. Display element 412 may include, for example, a graphical display such as a liquid crystal display.

In embodiments of the invention where vehicle module 118 is not used, mobile communication device 102 itself may be used to transmit the access control message, upon determining that mobile communication device 102 is in transit. There are varieties of means by which mobile communication device 102 can determine it is moving at a sufficient speed to indicate it is in a vehicle. For example, mobile communication device 102 may track the received signal strength indicator (RSSI) 413 of serving cell 109 and neighbor cell 111. If the signal strength changes at a sufficiently rapid rate, it may be used as an indication that mobile communication device 102 is in transit. Alternatively, the occurrence of a handover from a serving cell 109 to a neighbor cell 111 may be used as an indication that mobile communication device 102 is in transit. Another method that may be employed is the presence of a satellite-positioning receiver 414 in mobile communication device 102. By tracking location and time, mobile communication device 102 can easily determine velocity when it is in transit and determine that mobile communication device I102 is in transit in a vehicle.

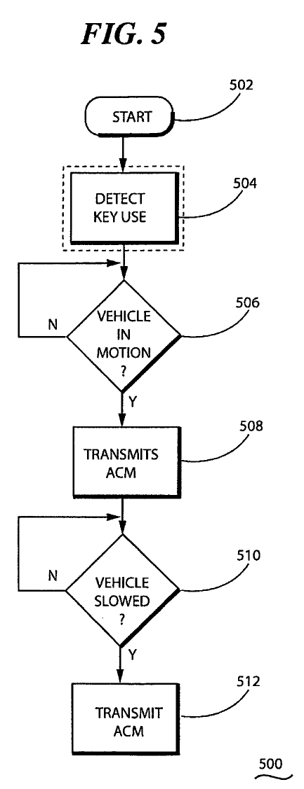

Referring now to FIG. 5, there is shown a flow chart diagram of a method 500 for controlling provisioning a mobile communication device 102 in accordance with an embodiment of the invention. The present diagram shows exemplary method steps associated with vehicle module 118. At the start, vehicle module 118 is powered on and appropriately programmed in accordance with the teachings herein. Vehicle module 118 may detect, in a step 504, the use of a key 302, 306 associated with the user of mobile communication device 102 to access or operate the vehicle. Upon detecting use of key 302, 306, vehicle module 118 may immediately transmit an access control message to the communication system 104. Alternatively, vehicle module 118 may detect when vehicle 106 is in motion in a step 506 or traveling at a preselected speed. When vehicle 106 is detected to be sufficiently moving, vehicle module 118 may then transmit access control message 508. Subsequently, vehicle module 118 detects when vehicle 106 has sufficiently slowed, or been turned off in a step 510, which will trigger a second access control message being transmitted in a step 512 to restore full communication service to mobile communication device 102. In this way, communication may be enabled in the less dangerous stop-and-go traffic, but disabled while driving around town or on a highway.

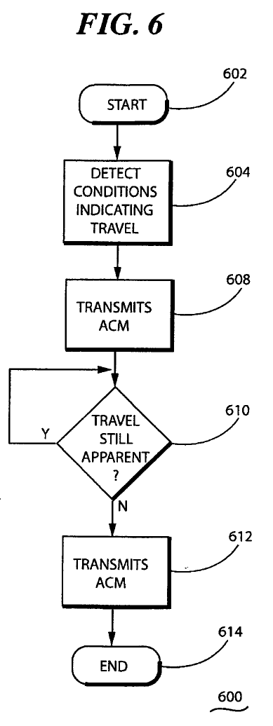

FIG. 6 is a flow chart diagram of a method 600 for controlling provisioning a mobile communication device 102 in accordance with yet another embodiment of the invention. The present method is used by mobile communication device 102 when, for example, vehicle module 118 is not used to transmit the access control message. In a first step 602, mobile communication device 102 is powered on and otherwise ready for communication service. While operating, mobile communication device 102 may track conditions in a step 604, which may indicate the device is in transit, such as, for example, changes in signal strength, positioning information, and handover information, as described above. Upon detecting conditions, which indicate that mobile communication device 102 is in transit, the device transmits an access control message in a step 608 to ACP 120 of communication system 104. Subsequently, the device monitors conditions in a step 610 to determine whether the device is still apparently in transit. Upon the conditions changing to indicate the device is no longer in transit, a second access control message may be transmitted in a step 612 to restore communications service, whereupon the method of the present example terminates in a step 614 until motion is again detected in step 604.

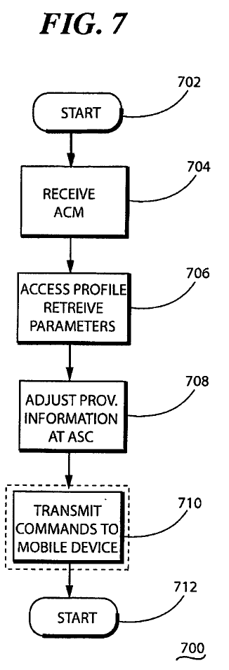

FIG. 7 further shows a flow chart of a method 700 for controlling provisioning a mobile communication device 102 in accordance with still another embodiment of the invention. The present example shows method elements undertaken by communication system 104 upon receiving the access control message. At the start, in a first step 702, communication system 104 has provisioned mobile communication device 102 for regular service. At some point, communication system 104 receives the access control message, which identifies, or allows identification of, the mobile communication device, which is to have provisioning changed in accordance with the parameters stored as a MAP 123. Communication system 104 accesses the access control processor 120 to retrieve the provisioning parameters from database 102 when communication device 102 is in motion, in a step 706. The provisioning parameters are used to adjust the present provisioning of service provided to mobile communication device 102 in a step 708. The provisioning parameters may include one or more allowed phone numbers from which mobile communication device 102 may receive calls, or to which mobile communication device 102 may place calls. Optionally, communication system 104 may transmit a control message to mobile communication device 102 in a step 710 to cause the device to shut off certain interfaces 408, 410, 412, such as a text-messaging interface 410. This will prevent a user from composing a text message, for example, and only upon trying to send the message discovering that messaging service has been restricted. By disabling the text messaging interface elements, the user will not even be allowed to compose a message, thus preventing use of mobile communication device 102 while in transit. The same methodology can block voice messaging as well. Communication system 104 may receive a second access control message indicating mobile communication device 102 is no longer in transit, whereupon regular communication service will be reprovisioned for the mobile communication device 102 and the method may then terminate in a step 712.

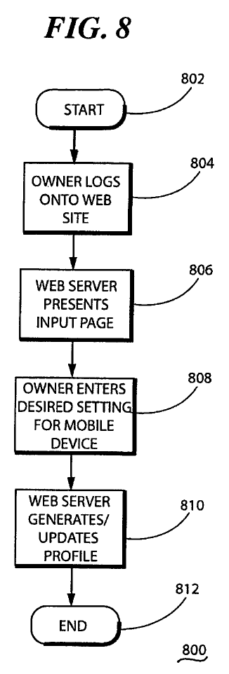

FIG. 8 shows a flow chart of a method 800 for generating or updating a mobility access profile 123 in accordance with an embodiment of the invention. In a first step 802, communication system 104 provides Internet access to a web server 124 to allow users and owners of mobile communication devices to enter and edit information in mobility access profiles 123. Accordingly, a user, or owner, or otherwise authorized person, logs onto web server 124 in a step 804 via an Internet connection 126. Web server 124 provides a web page or web pages requesting input in a step 806 and settings to be used as the parameters in adjusting provisioning of service for mobile communication device 102. Information is entered in a step 808 and by way of non-limiting example, may include the identity of the mobile communication device 102, the phone number assigned to the device 102, the identity of the vehicle module 118 which may transmit the access control message, and the allowed phone numbers which will not be restricted. Furthermore, emergency service numbers may be allowed by default. Once the information is entered, the web server 124 generates or updates the appropriate mobility access profile 123 in the access database in a step 810. The method then terminates in a step 812.

Although illustrative embodiments of the present invention have been described herein with reference to the accompanying drawings, it is to be understood that the present invention is not limited to those precise embodiments, and that the various other changes and modifications may be affected therein by one skilled in the art without departing from the scope and spirit of the invention. All such changes and modifications are intended to be included within the scope of the invention as defined by the appended claims.

What is claimed as new and desired to be protected by Letters Patent of the United States is:

1. A method for provisioning communication service provided to a mobile communication device by a communication system, comprising:
receiving an access control message at an access control processor of the communication system, the access control message indicating at least one of the mobile communication device is traveling and a vehicle associated with the mobile communication device is being operated; and
accessing a mobility access profile associated with the mobile communication device in response to the access control message, the mobility access profile including provisioning parameters associated with the mobile communication device, a mobile switching center of the communication system applying the parameters of the mobility access profile to control access to the mobile communication device.

2. A method for provisioning communication service as claimed in claim 1, wherein receiving the access control message comprises receiving the access control message from a vehicle module disposed in the vehicle associated with the mobile communication device.

3. A method for provisioning communication service as claimed in claim 2, wherein the vehicle module determines that the vehicle is in motion and transmits the access control message to the communication system in response to the determination.

4. A method for provisioning communication service as claimed in claim 2, wherein the vehicle module determines that a user of the mobile communication device has begun to operate the vehicle, the vehicle module transmitting the access control message to the communication system in response to detecting that the user has begun to operate the vehicle.

5. A method for provisioning communication service as claimed in claim 4, wherein the vehicle module detects that a key associated with the user of the mobile communication device has been used to access the vehicle and transmits the access control message in response to he detection of the key.

6. A method for provisioning communication service as claimed in claim 5, wherein the key is a wireless key.

7. A method for provisioning communication service as claimed in claim 1, wherein the mobile communication device determines that the mobile communication device is moving at a rate indicative of vehicular travel and produces the access control message in response to the determination that the communication device is moving at a rate indicative of vehicular travel.

8. A method for provisioning communication service as claimed in claim 7, wherein the mobile communication device uses a satellite positioning receiver disposed in the mobile communication device to determine that the mobile communication device is moving at the rate indicative of vehicular travel.

9. A method for provisioning communication service as claimed in claim 7, wherein the mobile communication device determines that the mobile communication device is moving at the rate indicative of vehicular travel as a function of changes in a received signal strength signal received from a serving cell transmitter.

10. A method for provisioning communication service as claimed in claim 1, wherein applying parameters associated with the mobile communication device comprises the step of prohibiting all non-allowed communication to the mobile communication device, wherein allowed communication is defined in the mobility access profile.

11. A method for provisioning communication service provided to a mobile communication device by a communication system, comprising:
generating a mobility access profile to be associated with the mobile communication device, the mobility access profile being maintained on an access database of the communication system and indicating at least allowed communication activity with the mobile communication device;
providing communication service to the mobile communication device;
receiving an access control message at an access control processor of the communication system, the access control message indicating at least one of the mobile communication devices is traveling and that a vehicle associated with the mobile communication device is being operated;
accessing the mobility access profile associated with the mobile communication device, the mobility access profile including provisioning parameters associated with the mobile communication device; and
applying provisioning parameters associated with the mobile communication device at a mobile switching center of the communication system in response to the access control message to allow only allowed communication activity by the mobile communication device in accordance with the mobility access profile.

12. A method for provisioning communication service as claimed in claim 11, wherein generating the mobility access profile comprises:
providing a web interface by a web server associated with the communication system;
receiving input via the web interface, the input indicating at least the allowed communication activity to be allowed upon adjusting the provisioning parameters associated with the mobile communication device; and
storing the input in the mobility access profile on the access database.

13. A method for provisioning communication service as claimed in claim 12, wherein receiving input includes receiving information indicating a non-allowed call is to be routed to a voice mail associated with the mobile communication device while the mobility access profile is applied to the provisioning of communication service provided to the mobile communication device.

14. A method for provisioning communication service as claimed in claim 11, wherein generating the mobility access profile comprises including emergency calling numbers in the allowed communication activity as a default.

15. A method for provisioning communication service as claimed in claim 11, further comprising the steps of transmitting a text messaging disable message to the mobile communication device to disable a text messaging interface of the mobile communication device while the mobility access profile is applied to the provisioning of communication service to the mobile communication activity.

16. A method for provisioning communication service as claimed in claim 11, wherein the access control message is received from a vehicle module disposed in the vehicle associated with the mobile communication device.

17. A method for provisioning communication service as claimed in claim 16, further comprising the steps of the vehicle module is the result of the vehicle module determining that the vehicle is in motion and subsequently transmitting the access control message to the communication system.

18. A method for provisioning communication service as claimed in claim 16, further comprising the steps of the vehicle module determining that a user of the mobile communication device has begun to operate the vehicle, the vehicle module transmitting the access control message to the communication system upon detection that the user of the communication device has begun to operate the vehicle.

19. A method for provisioning communication service as claimed in claim 18, further comprising the steps of detecting that a key associated with the user of the mobile communication device has been used to access the vehicle and transmitting the access control message in response to detecting that the key associated with the user of the mobile communication device has been used.

20. A method for provisioning communication service as claimed in claim 11, further comprising the steps of the communication device determining that it is moving at a rate indicative of vehicular travel and outputting the access control message in response to determining movement at a rate indicative of vehicular travel.
